(19) United States
(12) Patent Application Publication
(10) Pub. No.: US 2022/0004230 A1
(43) Pub. Date: Jan. 6, 2022

(54) CHEMICALLY STRENGTHENED GLASS AND FOLDABLE DEVICE

(71) Applicant: AGC INC., Tokyo (JP)

(72) Inventors: Izuru KASHIMA, Tokyo (JP); Yusuke FUJIWARA, Tokyo (JP)

(73) Assignee: AGC INC., Tokyo (JP)

(21) Appl. No.: 17/476,956

(22) Filed: Sep. 16, 2021

Related U.S. Application Data
(63) Continuation of application No. PCT/JP2020/012063, filed on Mar. 18, 2020.

(30) Foreign Application Priority Data
Mar. 18, 2019 (JP) 2019-050003

(51) Int. Cl. G06F 1/16

(52) U.S. Cl. CPC G06F 1/1652; C03C 21/002

(57) ABSTRACT

The present invention relates to a chemically strengthened glass including a first principal surface and a second principal surface which is on an opposite side of the first principal surface, and having a thickness of 0.30 mm or less, in which the chemically strengthened glass has a bent shape in which the first principal surface is a protrudent surface and the second principal surface is a recessed surface, and in which when the chemically strengthened glass is placed on a horizontal surface with the first principal surface facing downward, and no external force other than gravity acts on the chemically strengthened glass, part of the first principal surface is not in contact with the horizontal surface.

### TECHNICAL FIELD

The present invention relates to a chemically strengthened glass and a foldable device.

### BACKGROUND ART

Covers made of glass (cover glasses) are frequently used as protective covers for displays of various electronic appliances including smartphones, from the standpoint of improving appearance attractiveness. Glasses, although having high theoretical strength, considerably decrease in strength upon receiving scratches. Because of this, chemically strengthened glasses in which glass surfaces have a compression stress layer formed therein by, for example, ion exchange are used as cover glasses required to have strength such as impact strength.

Recently, foldable electronic appliances (foldable devices) including bendable displays have appeared. There is a desire for a chemically strengthened glass having flexibility for use as a cover glass for such displays.

For example, Patent Document 1 discloses a flexible, ultrathin, chemically strengthened glass. This ultrathin, chemically strengthened glass has a thickness t of less than 500 μm, an ion-exchanged-layer depth DOL of less than 30 μm, a surface compression stress CS of 100 to 700 MPa, and a center tensile stress CT of less than 120 MPa, the DOL, CS, and CT satisfying a specific relationship.

Patent Document 2 discloses an ultrathin, chemically strengthened glass having a glass thickness t of 0.4 mm or less, a DOL of less than 30 μm, a CS of 100 to 700 MPa, and a CT of less than 120 MPa, the DOL, CS, and CT satisfying a specific relationship.

### CITATION LIST

### Patent Literature

Patent Document 1: JP-T-2016-508954 (The term “JP-T” as used herein means a published Japanese translation of a PCT patent application.)

Patent Document 2: JP-T-2017-529304

### SUMMARY OF INVENTION

### Technical Problem

A preferred method for improving the strength of such a chemically strengthened glass having flexibility is to thicken the glass to such a degree that the flexibility can be ensured. However, the thickened glass has a high restoring force upon bending. In case where such a glass having a high restoring force in bending is used as the cover glass of a foldable device, this causes troubles, for example, that this foldable device is difficult to fold, the device in the folded state opens spontaneously, and the device, when opened, opens with vigor.

It has thus been difficult in flexible glasses to attain both an improvement in strength and a reduction in restoring force in bending.

An object of the present invention, in view of such problems, is to provide a chemically strengthened glass having flexibility and excellent strength and having a low restoring force in bending.

### Solution to Problem

A chemically strengthened glass of the present invention to solve the above-mentioned problems is a chemically strengthened glass including a first principal surface and a second principal surface which is on an opposite side of the first principal surface, and having a thickness of 0.30 mm or less,

in which the chemically strengthened glass has a bent shape in which the first principal surface is a protrudent surface and the second principal surface is a recessed surface, and

in which when the chemically strengthened glass is placed on a horizontal surface with the first principal surface facing downward, and no external force other than gravity acts on the chemically strengthened glass, part of the first principal surface is not in contact with the horizontal surface.

One embodiment of the chemically strengthened glass of the present invention is the chemically strengthened glass, which has a bent rectangular shape,

in which the first principal surface and the second principal surface each have a pair of unbent opposed edge portions,

in which when the chemically strengthened glass is placed on a horizontal surface with the first principal surface facing downward, and no external force other than gravity acts on the chemically strengthened glass, the chemically strengthened glass is capable of being cut along a plane passing through a first point which is a center of one of the unbent edge portions of the second principal surface, a second point which is a center of the other unbent edge portion of the second principal surface, a third point which is a center of one of the unbent edge portions of the first principal surface, and a fourth point which is a center of the other unbent edge portion of the first principal surface, and

in which the cutting along the plane results in a cross-sectional diagram in which the first point, a fifth point, and the second point form an angle θ of 165° or less, the fifth point being a point lying on the second principal surface and having a longest distance from a straight line connecting the first point and the second point.

One embodiment of the chemically strengthened glass of the present invention is the chemically strengthened glass, which has a restoring force in 10-mm bending, as measured by the following method, of 1.0 kgf or less:

(Method of measuring restoring force in 10-mm bending)

A chemically strengthened glass having a bent shape formed from a rectangular glass having a shorter-side length of 60 mm and a longer-side length of 120 mm by bending the rectangular glass along a line connecting centers of longer sides is used; a first support platen and a second support platen are disposed so that a support surface of the first support platen and a support surface of the second support platen face each other in parallel; one unbent edge portion of the first principal surface of the chemically strengthened glass and the other unbent edge portion of the first principal surface of the chemically strengthened glass are fixed respectively to the support surface of the first support platen and the support surface of the second support platen so that the unbent edge portions lie in the same position in a plan view; and a distance D between the support surface of the first support platen and the support surface of the second support platen is adjusted to 10 mm to measure a restoring force of the chemically strengthened glass in this state, the measured value being taken as the restoring force in 10-mm bending.

One embodiment of the chemically strengthened glass of the present invention is the chemically strengthened glass, which has a flat-state restoring force, as measured by the following method, of 1.0 kgf or less:

(Method of measuring flat-state restoring force)

A chemically strengthened glass having a bent shape formed from a rectangular glass having a shorter-side length of 60 mm and a longer-side length of 120 mm by bending the rectangular glass along a line connecting centers of longer sides is used; a first support platen and a second support platen are disposed so that a support surface of the first support platen and a support surface of the second support platen face each other in parallel; the chemically strengthened glass is placed on the support surface of the second support platen with the second principal surface facing downward; and a distance D between the support surface of the first support platen and the support surface of the second support platen is made equal to a thickness of the chemically strengthened glass to measure a restoring force of the chemically strengthened glass in this state, the measured value being taken as the flat-state restoring force.

A foldable device including a housing which has a deformable portion, and a flexible display, the foldable device being foldable along the deformable portion,

in which the flexible display includes a cover glass including the chemically strengthened glass of the present invention, and

in which the cover glass is disposed so as to be deformed in a bent portion of the foldable device in a folded state.

### Advantageous Effects of Invention

The chemically strengthened glass of the present invention has flexibility and excellent strength and has a low restoring force in bending.

### BRIEF DESCRIPTION OF DRAWINGS

FIG. 1 is a slant diagram illustrating one embodiment of the chemically strengthened glass of the present invention.

FIG. 2 is a side diagram illustrating one embodiment of the chemically strengthened glass of the present invention.

FIG. 3 is a side diagram illustrating a deformed state of one embodiment of the chemically strengthened glass of the present invention.

FIG. 4 is a side diagram illustrating a modification example of one embodiment of the chemically strengthened glass of the present invention.

FIG. 5 is a slant diagram illustrating one embodiment of the chemically strengthened glass of the present invention.

FIG. 6 is a cross-sectional diagram illustrating one embodiment of the chemically strengthened glass of the present invention.

FIG. 7 is a cross-sectional diagram illustrating a modification example of one embodiment of the chemically strengthened glass of the present invention.

FIG. 8 is a cross-sectional diagram illustrating another modification example of one embodiment of the chemically strengthened glass of the present invention.

FIG. 9 is a diagram for illustrating a bending tester.

FIG. 10 is a diagram for illustrating a method for measuring restoring force in 10-mm bending.

FIG. 11 is a diagram for illustrating a method for measuring flat-state restoring force.

FIG. 12 is a diagram for illustrating the method for measuring flat-state restoring force.

FIG. 13 is a schematic diagram illustrating a closed state of one embodiment of the foldable device of the present invention.

FIG. 14 is a schematic diagram illustrating an open state of one embodiment of the foldable device of the present invention.

### DESCRIPTION OF EMBODIMENTS

Embodiments of the present invention are described below. The present invention is not limited to the embodiments described below. In the following drawings, members or portions having like functions are sometimes designated by like signs, and duplications of explanation are sometimes omitted or simplified. The embodiments illustrated in the drawings are schematic ones for clearly explaining the present invention and do not always correctly show the actual sizes or scales.

### [Chemically Strengthened Glass]

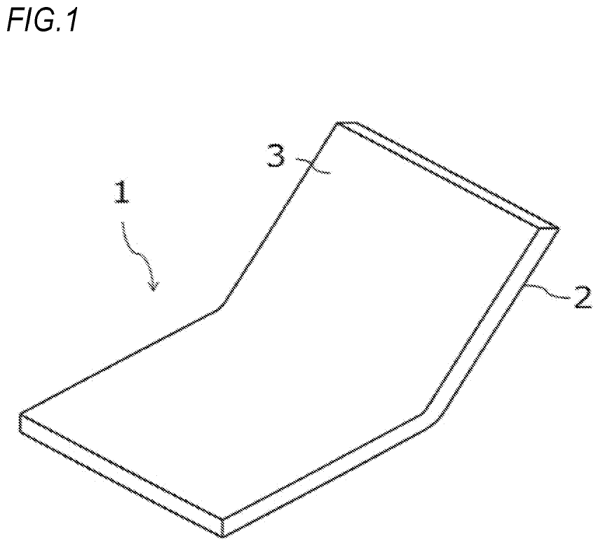

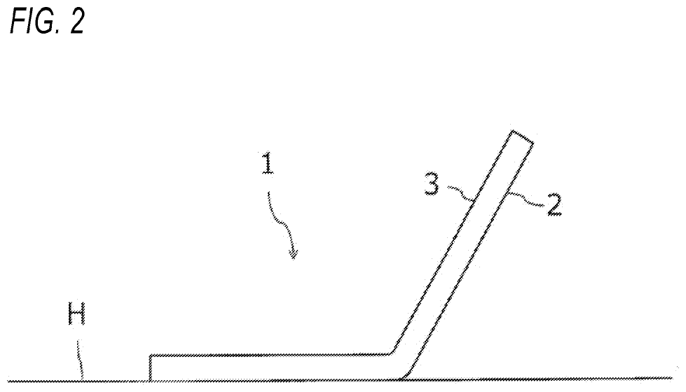

Schematic diagrams of a chemically strengthened glass according to the present embodiment (hereinafter often referred to also as “glass of the present embodiment”) are shown in FIG. 1 and FIG. 2. FIG. 1 is a slant diagram and FIG. 2 is a side diagram. The glass 1 of the present embodiment is a chemically strengthened glass including a first principal surface 2 and a second principal surface 3, which is on an opposite side of the first principal surface 2, and having a thickness of 0.30 mm or less.

The glass 1 of the present embodiment is undergone bending. That is, the glass 1 of the present embodiment has a bent shape in which the first principal surface 2 is a protrudent surface and the second principal surface 3 is a recessed surface. The term “bent shape” means that the glass 1 preferably has the shape of the letter V or U or is an approximately U-shaped, in a side view.

Consequently, when the glass 1 of the present embodiment is placed on a horizontal surface H, with the first principal surface 2 facing downward, and no external force other than gravity acts thereon, part of the first principal surface 2 is not in contact with the horizontal surface H. Conventional flexible glasses which have not undergone bending have a flat shape when not deflected and, hence, when such a conventional flexible glass is placed on a horizontal surface, and no external force other than gravity acts thereon, then the entire principal surface thereof on the horizontal-surface side is in contact with the horizontal surface. In this respect, the conventional flexible glasses differ from the glass 1 of the present embodiment.

The glass 1 of the present embodiment, which has the configuration described above, has a smaller deformation amount when deformed in a closing direction (the direction in which a degree of bending increases) than a deformation amount when flat-shaped glasses deformed into the same shape. Because of this, the glass 1 has a lower restoring force due to the deformation.

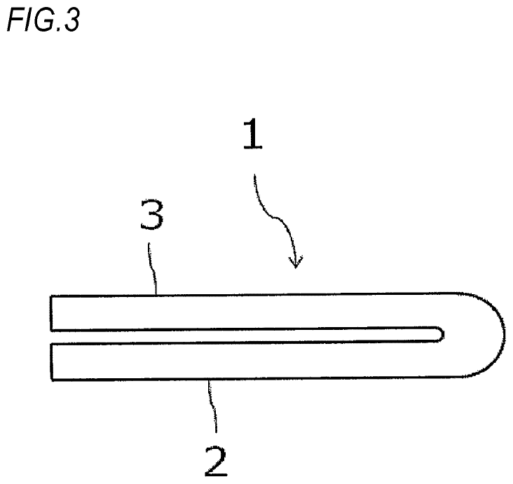

For example, in cases when a conventional flat-shaped glass is deformed into a folded shape as shown in FIG. 3, it is necessary to deform the glass by bending it by 180° and this results in a high restoring force. Meanwhile, the glass 1 of the present embodiment originally has a bent shape and is hence bent with a smaller deformation amount accordingly, resulting in a lower restoring force.

Thus, the glass 1 of the present embodiment has been made to have a reduced restoring force in bending not by a method that is accompanied with a decrease in strength, such as, for example, to reduce the plate thickness, but by a method in which the glass is made to have a bent shape when no external force other than gravity acts thereon and which is not accompanied with a decrease in strength. Because of this, the glass 1 of the present embodiment can combine improved strength and reduced restoring force.

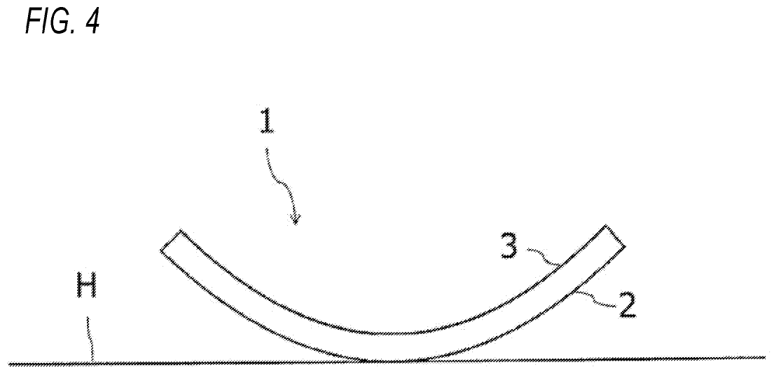

The glass 1 of the present embodiment is not limited in its shape so long as it satisfies the above-described requirements. For example, the glass 1 may have flat portions and a bent portion as shown in FIG. 1 and FIG. 2, or may have a shape which is entirely bent, like the modification example shown in FIG. 4.

From the standpoint of use as a cover glass for foldable devices, it is preferable that the first principal surface 2 and second principal surface 3 of the glass 1 of the present embodiment have a bent rectangular shape. It is more preferable that these principal surfaces each have: a pair of bent opposed edge portions which are U-shaped, approximately U-shaped, or V-shaped; and a pair of unbent opposed edge portions.

The degree of bending of the glass 1 of the present embodiment is also not particularly limited. However, from the standpoint of reducing the restoring force in bending in the closing direction, the degree of bending is preferably high.

Meanwhile, in case where the degree of bending is too high, the glass has an increased restoring force when deformed in the opening direction, and use of this glass as the cover glass of a foldable device causes troubles, for example, that this foldable device is difficult to open, the device in the open state folds spontaneously, and the device, when closed, closes with vigor.

The degree of bending of the glass 1 of the present embodiment can be evaluated with various indexes. For example, the degree of bending can be evaluated using an angle θ. The angle θ is explained below by reference to some of the drawings.

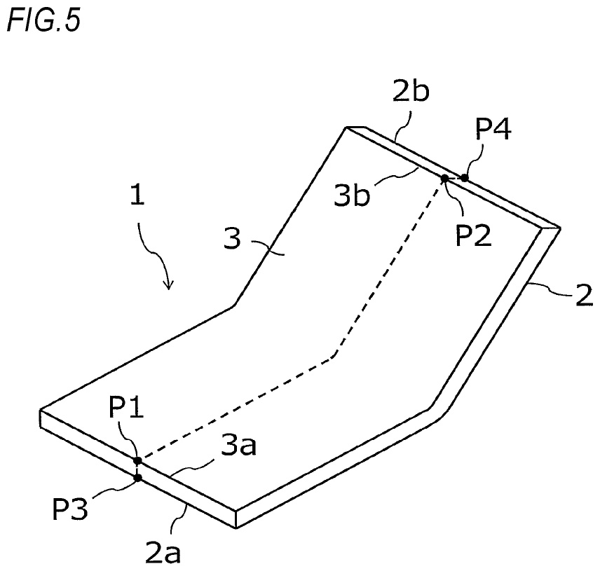

FIG. 5 shows a slant diagram of the glass 1 of the present embodiment in order to explain the angle θ. This glass has a bent rectangular shape, and the first principal surface 2 and the second principal surface 3 each have a pair of unbent opposed edge portions.

First, in cases when the chemically strengthened glass 1 is placed on a horizontal surface with the first principal surface 2 facing downward, and no external force other than gravity acts thereon, a center of one unbent edge portion 3a of the second principal surface 3 is referred to as a first point P1, a center of the other unbent edge portion 3b of the second principal surface 3 is referred to as a second point P2, a center of one unbent edge portion 2a of the first principal surface 2 is referred to as a third point P3, and a center of the other unbent edge portion 2b of the first principal surface 2 is referred to as a fourth point P4. Next, a cross-sectional diagram formed by cutting the chemically strengthened glass 1 along a plane passing through the first point P1, second point P2, third point P3, and fourth point P4 (i.e., the plane passing through the broken lines of FIG. 5) is discussed.

The cutting along the plane passing through the first point P1 to the fourth point P4 is possible when the bent portion of the chemically strengthened glass 1 perpendicularly intersects the line segments (broken lines) connecting the first point P1 and the second point P2 on the second principal surface. In other words, said cutting is possible when the bent portion of the chemically strengthened glass 1 perpendicularly intersects the line segments (broken lines) connecting the third point P3 and the fourth point P4 on the first principal surface.

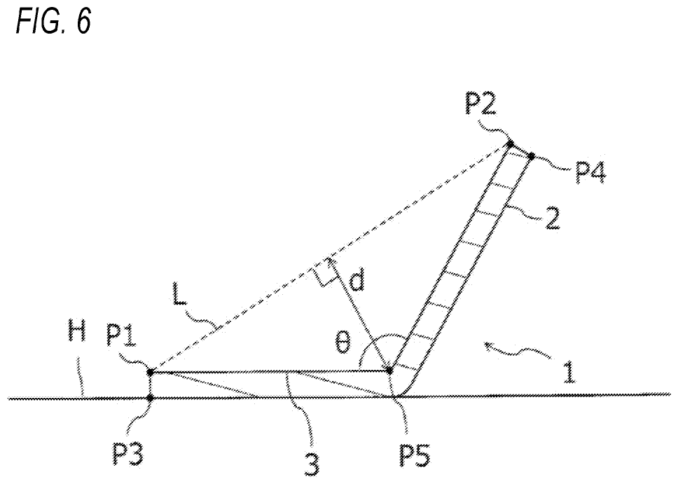

The expression “the bent portion of the chemically strengthened glass 1 perpendicularly intersects the line segments (broken lines) connecting the first point P1 and the second point P2” means that in cases when the chemically strengthened glass 1 is bent in the shape of the letter V as shown in FIG. 6, the linear bent portion as a valley perpendicularly intersects said line segments. In cases when the chemically strengthened glass 1 is bent in the shape of the letter U or of approximately the letter U, that expression means that the straight line serving as the axis of bending lies perpendicularly to said line segments.

FIG. 6 shows a cross-sectional diagram obtained by cutting the glass 1 of FIG. 5 in the manner shown above. In this cross-sectional diagram, the angle formed by the first point P1, the second point P2 and a fifth point P5, which is a point lying on the second principal surface 3 and having a longest distance d from a straight line L connecting the first point P1 and the second point P2, is referred to as angle θ.

The smaller the angle θ, the higher the degree of bending.

FIG. 5 and FIG. 6 show a glass example which has flat portions and is bent at around the center. This example is a case where the bent portion in the second principal surface 3 is linear, i.e., the glass is bent in the shape of the letter V.

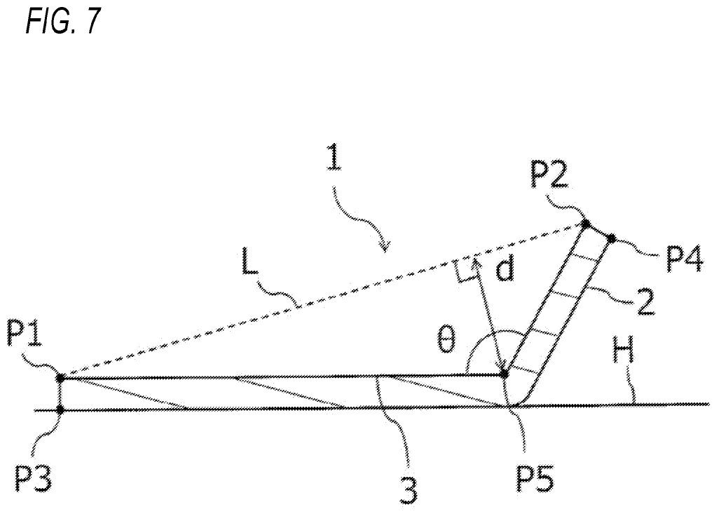

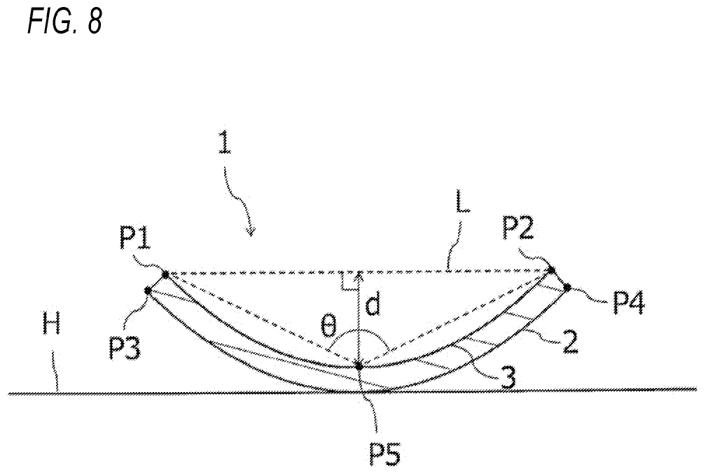

Meanwhile, even in glasses having different bent shapes, an angle θ can be determined similarly. Cross-sectional diagrams of modification examples having different shapes are shown in FIG. 7 and FIG. 8. Although the glass of the modification example shown in FIG. 7 has such a shape that the glass is bent at a position separated from around the center, an angle θ can be similarly determined in this glass also. Meanwhile, the glass of the modification example shown in FIG. 8 has such a shape that the glass is entirely bent and has no flat portion, that is, this glass is bent in the shape of a gentle letter “U”. In this glass also, an angle θ can be similarly determined from a first point P1, a fifth point P5, and a second point P2 as shown in FIG. 8.

The size of the angle θ may be appropriately regulated in accordance with uses of the glass 1 of the present embodiment. For example, the angle θ is preferably 15° or larger, more preferably 30° or larger, still more preferably 45° or larger, and is preferably 165° or less, more preferably 150° or less, still more preferably 135° or less.

In the case where the chemically strengthened glass 1 is bent in the shape of the letter U or of approximately the letter U, this glass 1 is not particularly limited in a radius of curvature at the fifth point P5 in the cross-sectional diagram. The radius of curvature may be appropriately regulated in accordance with uses of the glass 1 of the present embodiment.

A thickness of the glass 1 of the present embodiment is 0.30 mm or less for obtaining flexibility. From the standpoints of further improving the flexibility, reducing the weight, and attaining a reduced restoring force, the thickness of the chemically strengthened glass 1 of the present embodiment is preferably 0.25 mm or less, more preferably 0.20 mm or less, still more preferably 0.17 mm or less.

Meanwhile, from the standpoint of strength, the thickness of the glass 1 of the present embodiment is preferably 0.03 mm or larger, more preferably 0.04 mm or larger, still more preferably 0.05 mm or larger, yet still more preferably 0.07 mm or larger.

From the standpoint of strength, the glass 1 of the present embodiment preferably has a large value of surface compression stress (CS). By improving the strength by increasing the CS, not only the scratch resistance and the crack resistance are improved but also the glass is made less apt to crack even when bent and hence has improved flexibility. The CS of the glass 1 of the present embodiment is preferably 400 MPa or higher, more preferably 450 MPa or higher, still more preferably 500 MPa or higher.

Meanwhile, in case where the CS is too high, it is difficult to reduce the internal tensile stress (CT) which will be described later. Hence, the CS of the glass 1 of the present embodiment is preferably 1,200 MPa or less, more preferably 1,100 MPa or less, still more preferably 1,000 MPa or less.

The depth of the compression stress layer (DOL) of the glass 1 of the present embodiment is preferably 3 μm or larger, more preferably 5 μm or larger, still more preferably 7 μm or larger, especially preferably 8 μm or larger, from the standpoint of improving the strength to improve the scratch resistance, crack resistance, and flexibility.

Meanwhile, in case where the DOL is too large, it is difficult to reduce the internal tensile stress (CT) which will be described later. Hence, the DOL of the glass 1 of the present embodiment is preferably 25 μm or less, more preferably 20 μm or less, still more preferably 18 μm or less.

The internal tensile stress (CT) of the glass 1 of the present embodiment is preferably 250 MPa or less, more preferably 200 MPa or less, still more preferably 180 MPa or less, yet still more preferably 150 MPa or less, especially preferably 120 MPa or less, from the standpoint of inhibiting fragments of glass upon breakage from vigorously scattering.

The glass 1 of the present embodiment is not particularly limited in its composition so long as the base composition, i.e., the composition of the glass which has not undergone a chemical strengthening treatment, contains alkali metal ions. Examples of the base composition of the glass 1 of the present embodiment will be described in detail later.

The restoring force of the glass 1 of the present embodiment can be evaluated with various values. For example, the restoring force thereof can be evaluated with values measured by the following bending test.

### <Bending Test>

### (Bending Tester)

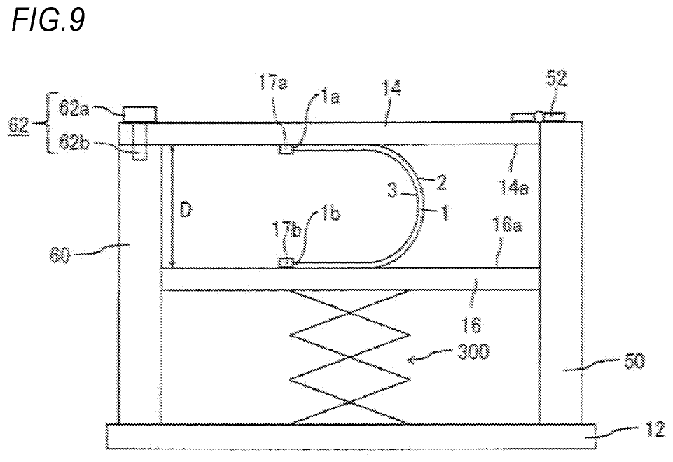

In FIG. 9 is shown a schematic diagram of a bending tester for use in the bending test. The bending tester is a device for deforming (curving) the chemically strengthened glass 1 of the present embodiment.

The bending tester includes a base 12, a first support platen (upper support platen) 14, a second support platen (lower support platen) 16, an adjusting part 300, a support part 50, and a placement part 60.

The first support platen 14 has a support surface 14a, which is a flat surface facing downward, and the second support platen 16 has a support surface 16a, which is a flat surface facing upward. These support surfaces are provided with stoppers which touch edge portions of the chemically strengthened glass 1, in accordance with test methods. Details are described later.

The adjusting part 300 adjusts a distance D between the support surface 14a of the first support platen 14 and the support surface 16a of the second support platen 16, which are parallel with each other. The adjusting part 300 is constituted of, for example, a pantograph type jack.

A support part 50 has been fixed to the base 12 and rotatably supports the first support platen 14 via a connecting part 52, e.g., hinges. The first support platen 14 is rotatable between a test position (first position) where the support surface 14a of the first support platen 14 is parallel with the support surface 16a of the second support platen 16 and a setting position (second position) where the support surface 14a of the first support platen 14 is oblique to the support surface 16a of the second support platen 16. While the first support platen 14 rotates from the test position to the setting position, the radius of curvature of the curved portion of a chemically strengthened glass supported by the first support platen 14 and the second support platen 16 increases gradually.

A placement part 60 has been fixed to the base 12, and the first support platen 14 to be disposed over the second support platen 16 is placed thereon. The first support platen 14, when lying in the test position, is placed on the upper end surface of the placement part 60. The first support platen 14 may be placed on a plurality of placement parts 60 in order to stabilize the posture of the first support platen 14. In each placement part 60, a bolt hole for screwing the shaft 62b of a bolt 62 thereinto is formed. In the first support platen 14, a through hole for passing the shaft 62b of the bolt 62 therethrough is formed. The first support platen 14 is sandwiched between a head 62a of the bolt 62 and each placement part 60. Thus, the posture of the first support platen 14 can be stabilized.

The glass 1 of the present embodiment is deformed (curved) using the bending tester under various conditions, during which required loads are measured. Thus, the glass 1 of the present embodiment can be evaluated for restoring force in bending. For measuring the loads, a load cell (not shown) can, for example, be used.

Values of restoring force in 10-mm bending or flat-state restoring force measured with, for example, a load cell under the conditions shown below can be used as indexes for evaluating restoring force in bending.

### (Restoring Force in 10-mm Bending)

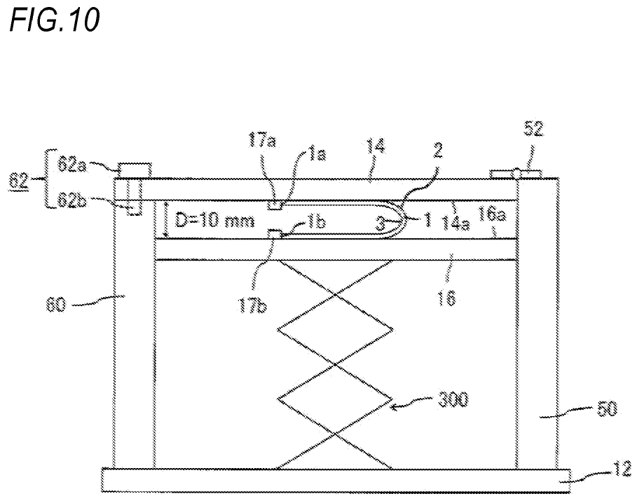

As a sample, use is made of a chemically strengthened glass having a bent shape formed from a rectangular glass having a shorter-side length of 60 mm and a longer-side length of 120 mm by bending the rectangular glass along a line connecting centers of longer sides. First, in measuring a restoring force in 10-mm bending, the support surface 14a of the first support platen 14 is provided with a stopper 17a which touches one unbent edge portion 1a of the chemically strengthened glass 1, and the support surface 16a of the second support platen 16 is provided with a stopper 17b which touches the other unbent edge portion 1b of the chemically strengthened glass 1. The stopper 17a and the stopper 17b are disposed so that during the test, the edge portions 1a and 1b of the chemically strengthened glass 1 are fixed in the same position in a plan view. Next, as FIG. 9 shows, the chemically strengthened glass 1 is disposed so that the edge portion 1a and the edge portion 1b touch the stopper 17a and the stopper 17b, respectively. Thereafter, as FIG. 10 shows, the first support platen 14 and the second support platen 16 are caused to approach each other, and the distance D between the support surface 14a of the first support platen 14 and the support surface 16a of the second support platen 16 is adjusted to 10 mm. The restoring force of the chemically strengthened glass 1 in this state is taken as the restoring force in 10-mm bending.

The glass 1 of the present embodiment is low in this restoring force in 10-mm bending.

The restoring force in 10-mm bending of the glass 1 of the present embodiment is preferably 1.0 kgf or less, more preferably 0.9 kgf or less, still more preferably 0.8 kgf or less, from the standpoint of attaining a reduced restoring force in bending in the closing direction. Although there is no particular lower limit, the restoring force in 10-mm bending thereof is usually 0.2 kgf or higher.

The restoring force in 10-mm bending is one measured by examining a glass having a bent shape formed from a rectangular glass having a shorter-side length of 60 mm and a longer-side length of 120 mm by bending the rectangular glass along a line connecting the centers of the longer sides. In cases when a glass having dimensions different from those shown above is examined for the restoring force in 10-mm bending, it is possible to conduct the same evaluation and convert the measured value using the glass size. The restoring force is proportional to the length of the shorter sides.

The restoring force in 10-mm bending can be regulated by appropriately regulating the thickness and angle θ of the glass 1 of the present embodiment, the radius of curvature of the bent portion thereof, the composition (base composition) thereof, conditions for various treatments in the production method which will be described later, etc. The same applies also in the flat-state restoring force described below.

### (Flat-State Restoring Force)

Since the glass 1 of the present embodiment in the state of receiving no external force has a bent shape, this glass 1 has a restoring force also when having been flattened unlike flat glasses.

In measuring the restoring force of a glass which has been flattened (hereinafter also referred to as “flat-state restoring force”), a chemically strengthened glass having a bent shape formed from a rectangular glass having a shorter-side length of 60 mm and a longer-side length of 120 mm by bending the rectangular glass along a line connecting centers of longer sides is used as a sample.

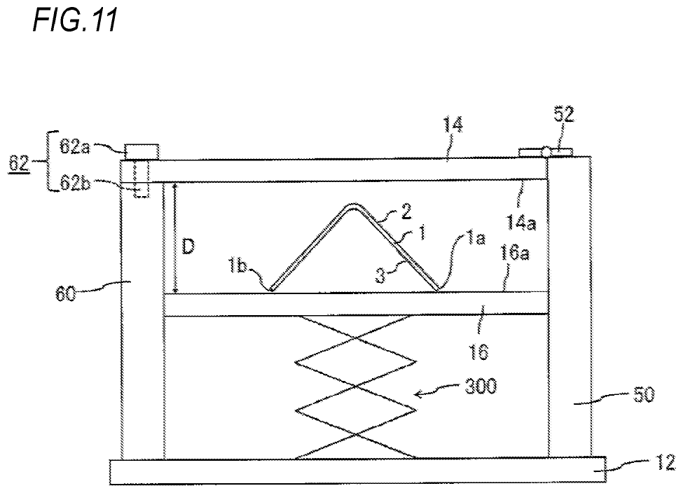

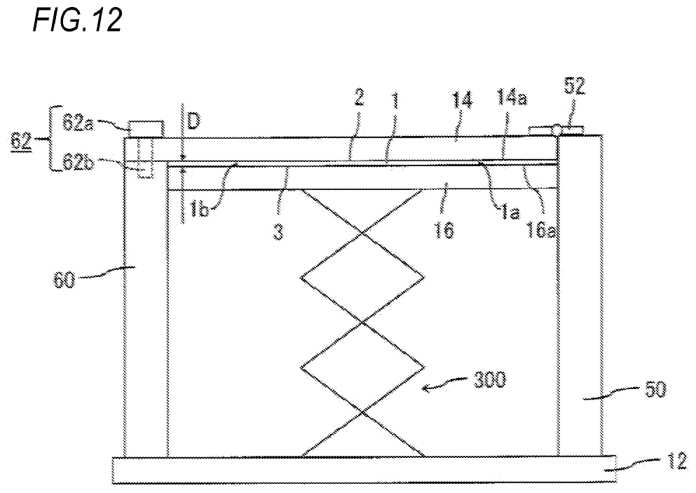

First, as FIG. 11 shows, the glass 1 is placed on the support surface 16a of the second support platen 16 of the bending tester so that the second principal surface 3 faces downward. Thereafter, the first support platen 14 and the second support platen 16 are caused to approach each other, and a restoring force measured at the time when the distance D between the support surface 14a of the first support platen 14 and the support surface 16a of the second support platen 16 has become equal to the thickness of the glass 1, as shown in FIG. 12, is taken as the flat-state restoring force. The glass 1 of the present embodiment differs from flat glasses in that the flat-state restoring force of the glass 1 of the present embodiment is not zero.

The flat-state restoring force of the glass 1 of the present embodiment is preferably 1.0 kgf or less, more preferably 0.9 kgf or less, still more preferably 0.8 kgf or less, from the standpoint of attaining a reduced restoring force in bending in the opening direction. Although there is no particular lower limit, the flat-state restoring force thereof is usually 0.2 kgf or higher.

The flat-state restoring force is one measured by examining a glass having a bent shape formed from a rectangular glass having a shorter-side length of 60 mm and a longer-side length of 120 mm by bending the rectangular glass along a line connecting the centers of the longer sides. In cases when a glass having dimensions different from those shown above is examined for the flat-state restoring force, it is possible to conduct the same evaluation and convert the measured value using the glass size. The restoring force is proportional to the length of the shorter sides.

### [Foldable Device]

Applications of the glass of the present embodiment are not particularly limited. However, an example of suitable applications is cover glasses for the flexible displays of foldable devices.

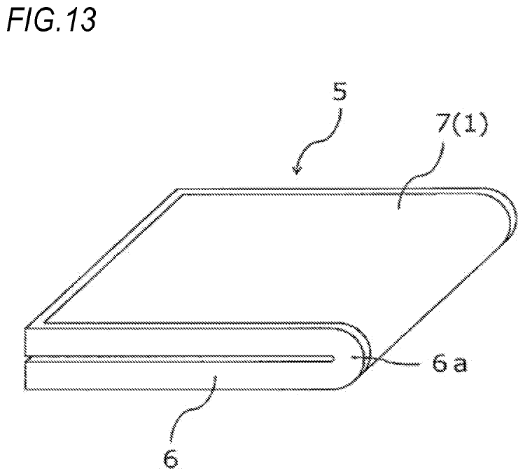

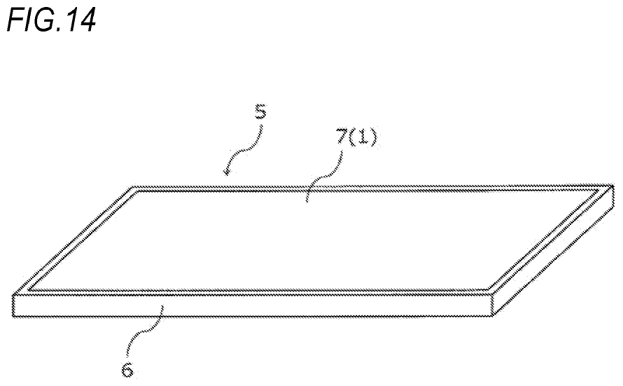

FIG. 13 and FIG. 14 show schematic diagrams of a foldable device (hereinafter often referred to also as “foldable device of the present embodiment”) including a cover glass including the chemically strengthened glass of the present embodiment. FIG. 13 is a schematic diagram illustrating a closed state and FIG. 14 is a schematic diagram illustrating an open state.

A foldable device 5 of the present embodiment includes a housing 6 and a flexible display 7.

The housing 6 includes a deformable portion 6a constituted of a hinge or a flexible member, and the flexible display 7 is a display having flexibility. Consequently, the foldable device 5 of the present embodiment is foldable along the deformable portion 6a of the housing 6, and can be deformed into various states including the closed state shown in FIG. 13 and the open state shown in FIG. 14. Although the housing 6 shown in FIG. 13 includes only one deformable portion, the housing 6 may include a plurality of deformable portions.

The flexible display 7 includes a cover glass 1 including the glass 1 of the present embodiment. The cover glass 1 is disposed so that when the foldable device 5 is deformed at the deformable portion 6a, the cover glass 1 is bent at the bent portion of the glass 1 of the present embodiment.

Since the foldable device 5 of the present embodiment has been thus configured, this foldable device 5 in the closed state is lower in restoring force due to the cover glass 1 than foldable devices employing flat glasses as the cover glasses. Consequently, the foldable device 5 of the present embodiment is less apt to cause troubles, for example, that the device is difficult to fold, the device in the folded state opens spontaneously, and the device, when opened, opens with vigor.

### [Method for Producing the Chemically Strengthened Glass]

Methods for producing the chemically strengthened glass of the present embodiment are not particularly limited. Use may be made of a method in which a bent shape is given to a flat glass for chemical strengthening and a chemical strengthening treatment is then given thereto or a method in which a chemical strengthening treatment is given to a flat glass for chemical strengthening and a bent shape is then given thereto. The term “glass for chemical strengthening” means a glass which has not undergone a chemical strengthening treatment.

The following is an explanation on one example of methods for producing the chemically strengthened glass of the present embodiment by giving a bent shape to a flat glass for chemical strengthening and then giving a chemical strengthening treatment thereto.

The example of methods for producing the chemically strengthened glass of the present embodiment, which is explained below, includes the following steps (1) to (4).

(1) Step for preparing a glass for chemical strengthening

(2) Cutting step

(3) Bending step

(4) Chemical strengthening treatment step

The step (1) for preparing a glass for chemical strengthening is a step in which a glass to be chemically strengthened is prepared.

The cutting step (2) is a step in which the glass for chemical strengthening is cut into a desired shape having desired dimensions.

The bending step (3) is a step in which the glass for chemical strengthening is bent to impart a bent shape thereto.

The chemical strengthening treatment step (4) is a step in which the glass for chemical strengthening to which the bent shape has been imparted is subjected to a chemical strengthening treatment to form a compression stress layer in the surfaces thereof.

### (1) Step for Preparing Glass for Chemical Strengthening

Methods for producing the glass for chemical strengthening are not particularly limited. Examples thereof include a method in which raw materials for glass prepared by suitably regulating the kinds and amounts thereof so as to obtain a desired composition are introduced into a continuous melting furnace, the mixture is heated and melted therein and refined, and the resultant molten glass is fed to a forming device, formed into a plate shape, and annealed.

For forming the glass, various methods can be employed. Examples thereof include downdraw processes (e.g., an overflow downdraw process, a slot down process, and a re-draw process), a float process, a rolling-out process, and a pressing process.

This glass forming may be conducted so as to obtain a glass sheet having a desired thickness. It is also possible to subject the formed glass to a thickness reduction treatment (slimming treatment) to make the formed glass have a desired thickness. Examples of methods for the slimming treatment include chemical etching, grinding, and polishing. Subjecting the formed glass to such a slimming treatment is preferred because this treatment removes minute scratches present in the glass surfaces to yield a glass having high strength. It is especially preferred to subject the formed glass to chemical etching.

The composition of the glass for chemical strengthening is not particularly limited so long as the composition can form a compression stress layer through a chemical strengthening treatment. Examples of the glass for chemical strengthening include aluminosilicate glass, soda-lime glass, borosilicate glass, lead glass, alkali barium glass, and aluminoborosilicate glass.

Examples of the composition of the glass for chemical strengthening include the following compositions. The following compositions are each expressed in terms of mol % based on an oxide.

(1) A glass including 50-80% SiO₂, 2-25% Al₂O₃, 0-10% Li₂O, 0-18% Na₂O, 0-10% K₂O, 0-15% MgO, 0-5% CaO, and 0-5% ZrO₂.

(2) A glass including 50-74% SiO₂, 1-10% Al₂O₃, 6-14% Na₂O, 3-11% K₂O, 2-15% MgO, 0-6% CaO, and 0-5% ZrO₂ in which a total content of SiO₂ and Al₂O₃ is 75% or less, a total content of Na₂O and K₂O is 12-25%, and a total content of MgO and CaO is 7-15%.

(3) A glass including 68-80% SiO₂, 4-10% Al₂O₃, 5-15% Na₂O, 0-1% K₂O, 4-15% MgO, and 0-1% ZrO₂.

(4) A glass including 67-75% SiO₂, 0-4% Al₂O₃, 7-15% Na₂O, 1-9% K₂O, 6-14% MgO, and 0-1.5% ZrO₂ in which a total content of SiO₂ and Al₂O₃ is 71-75%, a total content of Na₂O and K₂O is 12-20%, and a content of CaO, if it is contained, is less than 1%.

(5) A glass including 65-75% SiO₂, 0.1-5% Al₂O₃, 1-6% MgO, and 1-15% CaO in which a total content of Na₂O and K₂O is 10-18%.

(6) A glass including 60-72% SiO₂, 1-10% Al₂O₃, 5-12% MgO, 0.1-5% CaO, 13-19% Na₂O, and 0-5% K₂O in which RO/(RO+R₂O) is 0.20-0.42 (in the formula, RO represents a total content of alkaline-earth metal oxides and R₂O represents a total content of alkali metal oxides).

(7) A glass including 55.5-80% SiO₂, 12-20% Al₂O₃, 8-25% Na₂O, 2.5% or more of P₂O₅, and 1% or more of alkaline-earth metals RO (RO is MgO+CaO+SrO+BaO).

(8) A glass including 57-76.5% SiO₂, 12-18% Al₂O₃, 8-25% Na₂O, 2.5-10% P₂O₅, and 1% or more of alkaline-earth metals RO.

(9) A glass including 56-72% SiO₂, 8-20% Al₂O₃, 3-20% B₂O₃, 8-25% Na₂O, 0-5% K₂O, 0-15% MgO, 0-15% CaO, 0-15% SrO, 0-15% BaO, and 0-8% ZrO₂.

### (2) Cutting Step

The cutting step is a step for cutting the obtained glass for chemical strengthening into desired dimensions, and includes a step in which the glass for chemical strengthening is cut by chemical etching or with a short pulse laser. Glass cutting by chemical etching or with a short pulse laser is less apt to result in microcracks in the edge surfaces (surfaces formed by cutting) and hence gives high-strength glasses.

In the case where the glass for chemical strengthening is cut by chemical etching, a resist material is first applied to both surfaces of the glass for chemical strengthening and the resist material is exposed to light through a photomask having a desired pattern. The exposed resist material is developed to form a resist pattern in areas other than areas to be etched. Subsequently, the areas to be etched are etched to cut the glass for chemical strengthening.

Etchants are not particularly limited so long as the glass can be cut by etching therewith. For example, use can be made of a mixture of hydrofluoric acid with at least one acid selected from among sulfuric acid, nitric acid, hydrochloric acid, and hexafluorosilicic acid. The resist material is not particularly limited so long as it has resistance to the etchant, and can be suitably selected from known materials. Examples of remover liquids for the resist material include solutions of an alkali such as KOH or NaOH.

Although the step of cutting by etching described above is an example in which wet etching is employed, it is also possible to employ dry etching with fluorine gas. By thus cutting the glass by chemical etching, a glass is obtained in which the edge surfaces (surfaces formed by the cutting) have few microcracks and have extremely high smoothness.

In the case where the glass for chemical strengthening is cut with a short pulse laser, the glass is cut, for example, using a picosecond laser, a femtosecond laser, an attosecond laser, or the like as the short pulse laser and using a known device. By thus cutting the glass with a short pulse laser, a glass is obtained in which the edge surfaces have few microcracks and have extremely high smoothness.

After the cutting step and before the chemical strengthening treatment step, a step for chemical etching (edge surface treatment step) may be performed so that the edge surfaces are rounded.

For example, the edge surfaces of a glass formed by cutting by chemical etching sometimes have a sharp edge because the glass was isotropically etched from both sides. In such cases, there is a possibility that a fracture might be prone to occur from any of the edge surfaces. It is therefore preferred to sufficiently round the edge surfaces by the edge surface treatment step.

### (3) Bending Step

In the bending step, the glass for chemical strengthening which has been cut is bent to impart a bent shape thereto. Methods for the bending are not particularly limited. For example, the glass for chemical strengthening can be bent by subjecting the glass in the state of being bent at a desired angle and curvature to a heat treatment. A heating temperature and a heating period in the bending may be suitably regulated. Use may be made of a method in which the glass is heated to a temperature not lower than the glass transition point and shaped using a mold.

In the case where the chemical strengthening treatment step (4) is conducted before the bending step (3), a chemically strengthened glass is subjected to the step (3). In this case, the bending step may be conducted by the same method as in the case of the glass for chemical strengthening.

### (4) Chemical Strengthening Treatment Step

The chemical strengthening treatment is conducted by bringing the glass for chemical strengthening which has been bent into contact with an inorganic-salt composition containing alkali metal ions having a larger ionic radius than alkali metal ions contained in the glass. By this treatment, alkali metal ions (Li ions and/or Na ions) contained in the glass are replaced with larger alkali metal ions (Na ions and/or K ions) contained in the inorganic-salt composition to form a compression stress layer having a high density.

The density of the chemically strengthened glass gradually increases from the periphery of a region (intermediate layer) having not undergone ion exchange, which lies at the center of the glass, toward the surface of the compression stress layer. Hence, between the intermediate layer and the compression stress layer, there is no clear boundary where the density changes abruptly. In the case where the chemical strengthening treatment step (4) is conducted before the bending step (3), the glass for chemical strengthening which has not been bent is subjected to the step (4). In this case, the chemical strengthening treatment step may be conducted by the same method as in the case of the glass for chemical strengthening which has been bent.

Examples of methods for bringing the glass for chemical strengthening into contact with the inorganic-salt composition include: a method in which the inorganic-salt composition in a paste state is applied to the glass for chemical strengthening; a method in which an aqueous solution of the inorganic-salt composition is sprayed on the glass for chemical strengthening; and a method in which the glass for chemical strengthening is immersed in the inorganic-salt composition which has been melted by heating to the melting point or higher (hereinafter referred to also as “molten salt”). Preferred of these is the method in which the glass for chemical strengthening is immersed in the molten salt.

In the case where the glass for chemical strengthening contains Na ions, use may be made of an inorganic-salt composition which includes potassium nitrate (KNO₃) and further contains at least one flux selected from the group consisting of K₂CO₃, Na₂CO₃, KHCO₃, NaHCO₃, K₃PO₄, Na₃PO₄, K₂SO₄, Na₂SO₄, KOH, and NaOH.

Potassium nitrate has a melting point of 330° C., which is lower than the strain point (usually 500-600° C.) of the glass for chemical strengthening.

In the case of immersing the glass for chemical strengthening in a molten salt in conducting the chemical strengthening treatment, the glass for chemical strengthening is preheated to, for example, 100° C. or higher, immersed for a given period in the molten salt heated at a given temperature, and then pulled out of the molten salt and allowed to cool.

The temperature for the chemical strengthening may be any temperature not higher than the strain point (usually 500-600° C.) of the glass for chemical strengthening. However, the temperature is preferably 350° C. or higher from the standpoint of obtaining a large compression stress layer depth. From the standpoints of shortening the treatment period and promoting the formation of a low-density layer, the temperature is preferably 400° C. or higher, more preferably 430° C. or higher.

The time period during which the glass for chemical strengthening is immersed in the molten salt is preferably 1 minute to 10 hours, more preferably 5 minutes or longer, still more preferably 10 minutes or longer, and is more preferably 8 hours or less, still more preferably 4 hours or less, from the standpoint of balance between the strength of the chemically strengthened glass to be obtained and the compression stress layer depth thereof.

It is preferable that the method for producing the chemically strengthened glass of the present embodiment includes a step for cleaning the glass (cleaning step) after the chemical strengthening treatment step. In the cleaning step, the glass is cleaned using industrial water which has been treated according to need or using ion-exchanged water, etc. It is, however, especially preferred to use ion-exchanged water. Preferred cleaning conditions vary depending on cleaning liquids to be used. However, from the standpoint of completely removing the adherent salts, it is preferred to conduct the cleaning at 0-100° C. in the case of using, for example, ion-exchanged water. The cleaning step can be conducted by various methods including a method in which the chemically strengthened glass is immersed in a water tank containing ion-exchanged water or the like, a method in which the glass surfaces are rinsed in running water, and a method in which a cleaning liquid is jetted toward the glass surfaces with a shower.

### EXAMPLES

### Example 1

An alkali-containing flat glass having a shorter-side length of 60 mm, a longer-side length of 120 mm, and a thickness of 0.05 mm was subjected to a chemical strengthening treatment so as to result in a surface compression stress value of 900 MPa and a compression stress layer thickness of 7 sm. The obtained chemically strengthened glass was heated and bent using a mold so as to result in an angle θ, which was formed by the first point, fifth point, and second point described hereinabove, of 90°, thereby producing a chemically strengthened glass having the shape of a bent rectangle. The obtained chemically strengthened glass was examined for restoring force in 10-mm bending. As a result, the restoring force in 10-mm bending thereof was found to be 0.41 kgf.

### Comparative Example 1

A chemically strengthened glass having the shape of an unbent flat rectangle was produced in the same manner as in Example 1, except that the bending was omitted. The obtained chemically strengthened glass was examined for restoring force in 10-mm bending. As a result, the restoring force in 10-mm bending thereof was found to be 1.22 kgf.

Thus, the chemically strengthened glass which has undergone bending can have a reduced restoring force in bending.

While the invention has been described in detail and with reference to specific embodiments thereof, it will be apparent to one skilled in the art that various changes and modifications can be made therein without departing from the spirit and scope thereof. This application is based on a Japanese patent application filed on Mar. 18, 2019 (Application No. 2019-050003), the contents thereof being incorporated herein by reference.

### REFERENCE SIGNS LIST

1 Chemically strengthened glass (cover glass, glass)
1a, 1b Edge portions of chemically strengthened glass
2 First principal surface
2a One unbent edge portion of first principal surface
2b Other unbent edge portion of first principal surface
3 Second principal surface
3a One unbent edge portion of second principal surface
3b Other unbent edge portion of second principal surface
P1 First point
P2 Second point
P3 Third point
P4 Fourth point
P5 Fifth point
5 Foldable device
6 Housing
6a Deformable portion
7 Flexible display
12 Base
14 First support platen (upper support platen)
14a Support surface of first support platen
16 Second support platen (lower support platen)
16a Support surface of second support platen
17a, 17b Stoppers
50 Support part
52 Connecting part
60 Placement part
62 Bolt
62a Head of bolt
62b Shaft of bolt
300 Adjusting part

1. A chemically strengthened glass comprising a first principal surface and a second principal surface which is on an opposite side of the first principal surface, and having a thickness of 0.30 mm or less,
wherein the chemically strengthened glass has a bent shape in which the first principal surface is a protrudent surface and the second principal surface is a recessed surface, and
wherein when the chemically strengthened glass is placed on a horizontal surface with the first principal surface facing downward, and no external force other than gravity acts on the chemically strengthened glass, part of the first principal surface is not in contact with the horizontal surface.

2. The chemically strengthened glass according to claim 1, which has a bent rectangular shape,
wherein the first principal surface and the second principal surface each have a pair of unbent opposed edge portions,
wherein when the chemically strengthened glass is placed on a horizontal surface with the first principal surface facing downward, and no external force other than gravity acts on the chemically strengthened glass, the chemically strengthened glass is capable of being cut along a plane passing through a first point which is a center of one of the unbent edge portions of the second principal surface, a second point which is a center of the other unbent edge portion of the second principal surface, a third point which is a center of one of the unbent edge portions of the first principal surface, and a fourth point which is a center of the other unbent edge portion of the first principal surface, and
wherein the cutting along the plane results in a cross-sectional diagram in which the first point, a fifth point, and the second point form an angle θ of 165° or less, the fifth point being a point lying on the second principal surface and having a longest distance from a straight line connecting the first point and the second point.

3. The chemically strengthened glass according to claim 1, which has a restoring force in 10-mm bending, as measured by the following method, of 1.0 kgf or less:
(Method of measuring restoring force in 10-mm bending)
A chemically strengthened glass having a bent shape formed from a rectangular glass having a shorter-side length of 60 mm and a longer-side length of 120 mm by bending the rectangular glass along a line connecting centers of longer sides is used; a first support platen and a second support platen are disposed so that a support surface of the first support platen and a support surface of the second support platen face each other in parallel; one unbent edge portion of the first principal surface of the chemically strengthened glass and the other unbent edge portion of the first principal surface of the chemically strengthened glass are fixed respectively to the support surface of the first support platen and the support surface of the second support platen so that the unbent edge portions lie in the same position in a plan view; and a distance D between the support surface of the first support platen and the support surface of the second support platen is adjusted to 10 mm to measure a restoring force of the chemically strengthened glass in this state, the measured value being taken as the restoring force in 10-mm bending.

4. The chemically strengthened glass according to claim 1, which has a flat-state restoring force, as measured by the following method, of 1.0 kgf or less:
(Method of measuring flat-state restoring force)
A chemically strengthened glass having a bent shape formed from a rectangular glass having a shorter-side length of 60 mm and a longer-side length of 120 mm by bending the rectangular glass along a line connecting centers of longer sides is used; a first support platen and a second support platen are disposed so that a support surface of the first support platen and a support surface of the second support platen face each other in parallel; the chemically strengthened glass is placed on the support surface of the second support platen with the second principal surface facing downward; and a distance D between the support surface of the first support platen and the support surface of the second support platen is made equal to a thickness of the chemically strengthened glass to measure a restoring force of the chemically strengthened glass in this state, the measured value being taken as the flat-state restoring force.

5. A foldable device comprising a housing which has a deformable portion, and a flexible display, the foldable device being foldable along the deformable portion,
wherein the flexible display comprises a cover glass comprising the chemically strengthened glass according to claim 1, and
wherein the cover glass is disposed so as to be deformed in a bent portion of the foldable device in a folded state.
